(19) United States
(12) Patent Application Publication
(10) Pub. No.: US 2014/0108591 A1
(43) Pub. Date: Apr. 17, 2014

(54) Methods And Systems For Delivering Individualized Content

(71) Applicants: Matthew J. Daviduk, Lewis Center, OH (US); Timothy K. Ebbers, Johnstown, OH (US)

(72) Inventors: Matthew J. Daviduk, Lewis Center, OH (US); Timothy K. Ebbers, Johnstown, OH (US)

(73) Assignee: Victoria's Secret Stores Brand Management, Inc., Reynoldsburg, OH (US)

(21) Appl. No.: 13/650,401

(22) Filed: Oct. 12, 2012

(51) Int. Cl. G06F 15/16

(52) U.S. Cl. 709/217

(57) ABSTRACT

This disclosure relates to methods and systems for delivering content. In one aspect, a method is disclosed that receives a request for content from a requestor and searches for a trigger in the response to that request. In response to identifying a trigger in the content, the method inserts content that is individualized for the requestor into the response.

### BACKGROUND

Conventional systems for delivering content over a network such as the internet typically operate in a two-way manner. That is, one computer may send a request for content, while another computer, such as a server, receives the request, determines the proper response, and transmits the content to the requestor. The requestor may then display or otherwise manipulate the content.

In certain circumstances, it may be desirable to deliver individualized content to a requestor. Conventional content delivery systems handle this in one of two ways. In one conventional system, the server receives the request and an indication of the identity of the requestor. The server then determines the appropriate response for that particular requestor. This conventional system places strain on the server, which can result in reduced performance.

In a second conventional solution, the requestor can receive all of the possible combinations of individualized content. The requestor can then determine, based on its identity or other information, which content to display. This conventional system may alleviate some of the load on the server, but increases the load on the requestor, and increases the total amount of traffic that must travel over the network.

### SUMMARY

It is to be understood that both the following general description and the following detailed description are exemplary and explanatory only and are not restrictive, as claimed. Provided are methods and systems for delivering individualized content.

In one aspect, a method for delivering content is provided. The method receives a request for content from a requestor and receives a response to the request. The method then searches for a trigger in the response. In response to identifying a trigger in the response, the method inserts content that is individualized for the requestor into the response. The response and content individualized for the requestor can be a markup language, and the trigger can be a variable in the markup language. Inserting the content individualized for the requestor into the response can include replacing the trigger with the content. The content individualized for the requestor can be the number of items the requestor has placed in a shopping cart. In addition, the method can intercept the response after the response has been sent by a server. The method can then scan the response for the trigger prior to transmitting the response to the requestor.

In another aspect, a method for delivering content receives a request for content from a requestor. The method identifies information pertaining to the requestor and identifies a source for content to be delivered to the requestor based on the information. The method then requests information from the source and delivers content from the source to the requestor. The information can be at least one of a browser type, a browser version, an operating system, a media player type, a location, an IP address, an internet provider, a time of day, a system load, a random number, and a visit frequency.

There can be more than one source of content, and each such source of content can be associated with the information. The request for content can then be directed to the source that is associated with the information. A first source of content can be configured to deliver a first version of a website, while a second source of content can be configured to deliver a second version of a website. The source of the content to be delivered can be a server, and the step of identifying information pertaining to the requestor can be performed by a load balancer.

In yet a further aspect, a system for delivering content is disclosed. The system can include multiple servers, each of which is configured to deliver different content, and a load balancer that has an association between information pertaining to a request and each of the plurality of servers. In response to receiving a request, the load balancer identifies information pertaining to the request and directs the request to the server that is associated with the information pertaining to the request. The information pertaining to the request can be a browser type, a browser version, an operating system, a media player type, a location, an IP address, an internet provider, a time of day, a system load, a random number, and a visit frequency. The server can be a web server, and the content can be markup language.

The load balancer can intercept a response from the server, scan that response for a trigger before sending it back to the requestor, and insert content individualized for the requestor into the response before transmitting the response to the requestor. Inserting the content individualized for the requestor can include replacing the trigger with that content. The content individualized for the requestor can include the number of items that the requestor has placed in a shopping cart.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram illustrating an exemplary system in which the methods and systems described herein can operate;

FIG. 2 is a block diagram illustrating an exemplary embodiment of a system for delivering individualized content in accordance with the methods and systems described herein;

FIG. 3 is a flow chart illustrating an exemplary method of delivering individualized content in accordance with the methods and systems described herein;

FIG. 4 is a flow chart illustrating an exemplary method for requesting client-specific content in accordance with the methods and systems described herein; and

FIG. 5 is a flow chart illustrating an exemplary method for inserting client-specific content in accordance with the methods and systems described herein.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

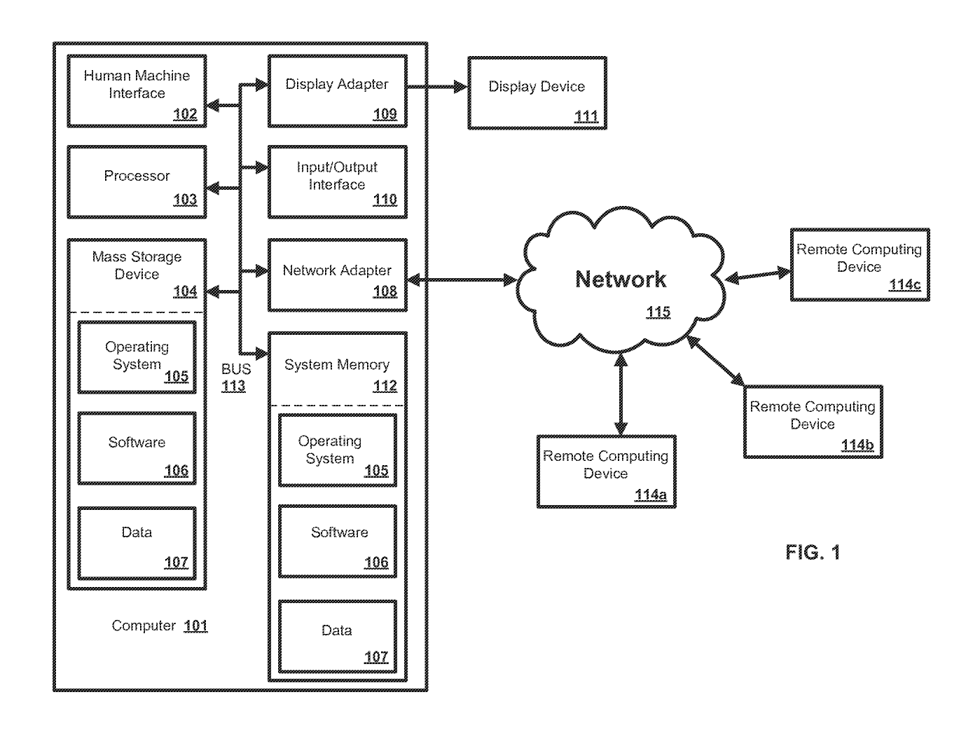

FIG. 1 illustrates various aspects of an exemplary system in which the present methods and systems can operate. The present disclosure relates to methods and systems for delivering individualized content. Those skilled in the art will appreciate that present methods may be used in systems that employ both digital and analog equipment. One skilled in the art will appreciate that provided herein is a functional description and that the respective functions can be performed by software, hardware, or a combination of software and hardware.

In an exemplary aspect, the methods and systems can be implemented on a computer 101 as illustrated in FIG. 1 and described below. The methods and systems disclosed can utilize one or more computers to perform one or more functions in one or more locations. FIG. 1 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 101. The components of the computer 101 can comprise, but are not limited to, one or more processors or processing units 103, a system memory 112, and a system bus 113 that couples various system components including the processor 103 to the system memory 112. In the case of multiple processing units 103, the system can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, software 106, data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computer 101 typically comprises a variety of computer readable media. Exemplary readable media can be any available media that is accessible by the computer 101 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 may contain data such as media, video, audio, program code, markup language, or other data 107 and/or program modules such as operating system 105 and software 106 capable of receiving requests for content, identifying the appropriate content with which to respond, and intercepting and replacing content with individualized content that can include the data 107 that are immediately accessible to and/or are presently operated on by the processing unit 103.

In another aspect, the computer 101 can also comprise other removable/non-removable, volatile/non-volatile computer storage media. By way of example, FIG. 1 illustrates a mass storage device 104 which can provide non-volatile storage of computer code, computer readable instructions, data structures, program modules, and other data for the computer 101. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and content delivery software 106. Each of the operating system 105 and content delivery software 106 (or some combination thereof) can comprise elements of the programming and the content delivery software 106. Media, video, audio, program code, markup language, or other data 107 can also be stored on the mass storage device 104. Media, video, audio, or other data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 101 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. It is contemplated that the computer 101 can have more than one display adapter 109 and the computer 101 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to the computer 101 via Input/Output Interface 110. Any step and/or result of the methods can be output in any form to an output device. Such output can be any form of visual representation, including, but not limited to, textual, graphical, animation, audio, tactile, and the like. The display 111 and computer 101 can be part of one device, or separate devices.

The computer 101 can operate in a networked environment using logical connections to one or more remote computing devices 114a,b,c. By way of example, a remote computing device can be a personal computer, portable computer, smartphone, a server, a router, a network computer, a peer device or other common network node, and so on. Logical connections between the computer 101 and a remote computing device 114a,b,c can be made via a network 115, such as a local area network (LAN) and/or a general wide area network (WAN). Such network connections can be through a network adapter 108. A network adapter 108 can be implemented in both wired and wireless environments. Such networking environments are conventional and commonplace in dwellings, offices, enterprise-wide computer networks, intranets, and the Internet.

For purposes of illustration, application programs and other executable program components such as the operating system 105 are illustrated herein as discrete blocks, although it is recognized that such programs and components reside at various times in different storage components of the computing device 101, and are executed by the data processor(s) of the computer. An implementation of content delivery software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

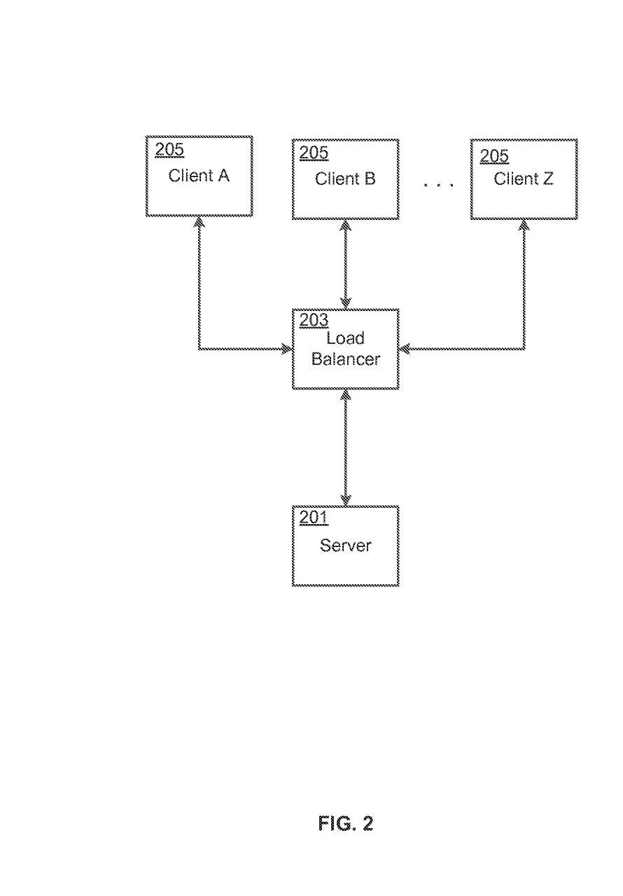

Turning now to FIG. 2, a block diagram illustrating an exemplary embodiment of a system for delivering individualized content in accordance with the methods and systems described herein is shown. The system includes at least one server 201. In an exemplary embodiment, the server 201 is a computer or collection of computers configured to receive requests for content, information, or the like, and to respond to those requests. The server 201 can be, for example, a World Wide Web server 201, and can be configured with software that can transmit hypertext markup language (HTML) data and other content in response to requests from remote computing devices. As one of skill in the art would understand, the server 201 can be any type of computer that is configured to receive requests for information and to respond to those requests.

The system can include multiple servers 201. In one exemplary embodiment, each server 201 serves the same content in response to a given request. In this embodiment, the servers 201 act to smooth out the burden of a large number of requests or heavy processing. In an alternative exemplary embodiment, the servers 201 can provide varying content in response to a request. Although each server 201 may be contained on a single computer, a single computer can also include multiple servers 201, wherein each server 201 can be accessed separately through an identifier, such as, by way of example only, a name or a logical path.

The system also includes a load balancer 203. In an exemplary embodiment, the load balancer 203 is a computer or network of computers that have access to traffic passing between remote computers, such as client 205 and the server 201. In an alternative exemplary embodiment, the load balancer 203 can be a special purpose computer that is designed to retrieve and operate on data and content more quickly than a server 201. For example, the load balancer 203 can include non-magnetic storage systems, relying instead on solid-state memory systems, such as dynamic random access memory (DRAM) or flash memory.

In an exemplary embodiment, the client 205 is a computer that is capable of connecting to a network that allows requests to be made to the. By way of example, client 205 can be a desktop or laptop personal computer, mobile telephone, smartphone, tablet pc, workstation, set top box, or other network enabled device.

Returning to discussion of the load balancer 203, the exemplary load balancer 203 is configured to receive a request for content from a requestor, such as, for example, a client 205, and pass that request to the server 201. If the system includes multiple servers 201, the load balancer 203 can direct requests to a server 201 that is appropriate to handle the request. For example, the load balancer 203 can examine the relative load on multiple servers 201 within the system, and direct the request to a server 201 that is under a lesser load. One of skill in the art would understand that there are numerous performance-based metrics that the load balancer 203 can use to determine where to route traffic.

In an exemplary embodiment, the load balancer 203 can also direct a request to a particular server 201 so that the response contains content that is individualized to the request or requestor. The load balancer 203 can determine the identity of the requestor (or other information about the request or the requestor), and direct the request to a particular server 201. The identity of the requestor can be determined in a variety of ways, for example, by examining the network address from which the request originated or other information that may be transmitted with the request. By way of example only, in the context of hypertext transfer protocol (HTTP) requests over the internet, the request typically includes a variety of information about the requestor, as one of skill in the art would understand. The request can also include custom information about the requestor that is stored on the requestor's computer in the form of a “cookie,” which one of skill in the art would understand as a term of art for a small amount of information that is placed on the requestor's computer that can be used to identify the requestor, but also to store information about the requestor, such as the requestor's preferences, information about the requestor's visits or other activity on a website, or other information about the requestor.

In the exemplary embodiment, the appropriate server 201 for a particular request can be determined in a variety of ways. For example, the load balancer 203 can include a database, table, list, or other data structure that correlates information pertaining to a request to a given server 201. By way of example, the load balancer 203 can correlate a certain value in a given cookie with a certain server 201. As one of skill in the art would understand, any information pertaining to the request can be correlated with a given server 201.

This embodiment provides the capability to, for example, direct different content to discrete visitors of a website, which can be useful for a wide variety of applications, including user customization and testing. By way of example, new versions of web pages are sometimes tested by delivering new versions to certain users, while continuing to deliver the current version to others. This process is sometimes referred to as A/B testing. In certain conventional A/B testing procedures, both versions of a website are transmitted to the requestor, then, program code, such as, by way of example, Javascript running on the requestor's computer chooses which version of the website to run. This is inefficient because it overuses network and requestor resources to transmit and store content that the requestor will not experience.

In this embodiment, on the other hand, after the load balancer 203 obtains the identity of the requestor, it can direct the request to a selected server 201 that will respond with one version of the website. The load balancer 203 can, alternatively, direct the request to a second server 201 that will respond with a second version of the website. As one of skill in the art would understand, the load balancer 203 is not limited to basing the decision to direct the request on the identity of the requestor. Rather, the load balancer 203 can direct the request based on any information pertaining to the requestor or the request, such as, by way of example, browser type, browser version, operating system, media viewer/player type, location, IP address, internet provider, time of day, system load, random number, visit frequency, and the like. By only sending the content that the requestor will use, the system uses network and client 205 resources more efficiently. In view of the continuing increase in use of mobile data and cellular data networks, in which both client 205 and network resources tend to be more limited, all efficiencies gained are valuable.

In an alternative exemplary embodiment, the load balancer 203 can intercept responses from the server 201 before passing the response on to a requestor such as a client 205. The load balancer 203 can then insert individualized content into the response. In an exemplary embodiment, the load balancer 203 will examine the response for certain keys or triggers, and will insert certain content near or in place of such a key or trigger. The term key or trigger is not intended to be limiting, but rather, is intended to convey the general concept of a marker or other searchable information within a response.

By way of example, if a response is a hypertext markup language (HTML) document, the load balancer 203 can trigger off of a known HTML construct, such as the “img src=” tag. Upon identifying the “img src=” tag, the load balancer 203 can replace the value associated with that tag with the path to an image that has been chosen for the user making the request.

As another example, the load balancer 203 can replace information that tends to change over the course of a given interaction with the server 201. In the context of online retail, the number of items in a user's shopping cart is one such piece of information. In conventional systems, the contents of the users shopping cart are stored on the server 201. Each time the item count is checked or updated, the client 205 must query the server 201, which must query the shopping cart information, calculate the number of items in the cart, and refresh the page. This process requires multiple transactions with the server 201, which is inefficient in itself, and problematic in a mobile environment where network and client resources are at a premium.

The alternative exemplary embodiment, however, would alleviate this inefficiency. In this embodiment, the load balancer 203 would trigger off of the variable in the HTML that represents the shopping cart item count. The load balancer 203 would intercept that variable and query the server 201 for the proper shopping cart count for that user and insert it into the HTML. The HTML, now loaded with the individualized shopping cart count value for that client 205, would be transmitted to the client 205 and displayed. In this way, the shopping cart update process would involve fewer network transactions, thus improving efficiency.

The load balancer 203 of the alternative exemplary embodiment is not limited to replacing variables in HTML, but rather, is capable of identifying any sequence of data and inserting (or replacing it with) any other sequence in response to a request. For example, if the client 205 has requested a binary file, the load balancer 203 can identify the beginning and ending signals of such file and replace it with another.

Although in the exemplary embodiment the load balancer 203 is disclosed as positioned as a separate component from the server 201, as one of ordinary skill in the art would understand, the server 201 and the load balancer 203 can coexist on a single system. In addition, the load balancer 203 need not be co-located with the server 201, but rather, can be coupled to the server 201 via a wireless or wired network.

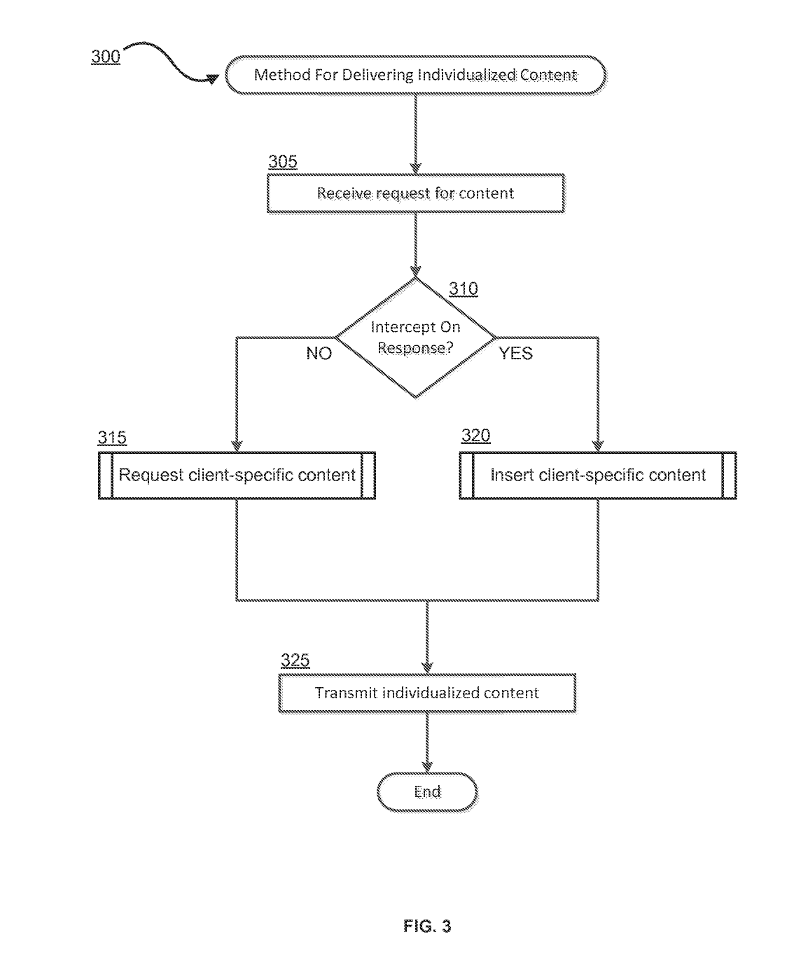

Turning now to FIG. 3, a flow chart illustrating an exemplary method 300 for delivering individualized content is disclosed. FIG. 3 will be discussed with reference to FIG. 1 and FIG. 2. Beginning with step 305, a request for content is received. In an exemplary embodiment, the request originates from the client 205 and seeks content from the server 201.

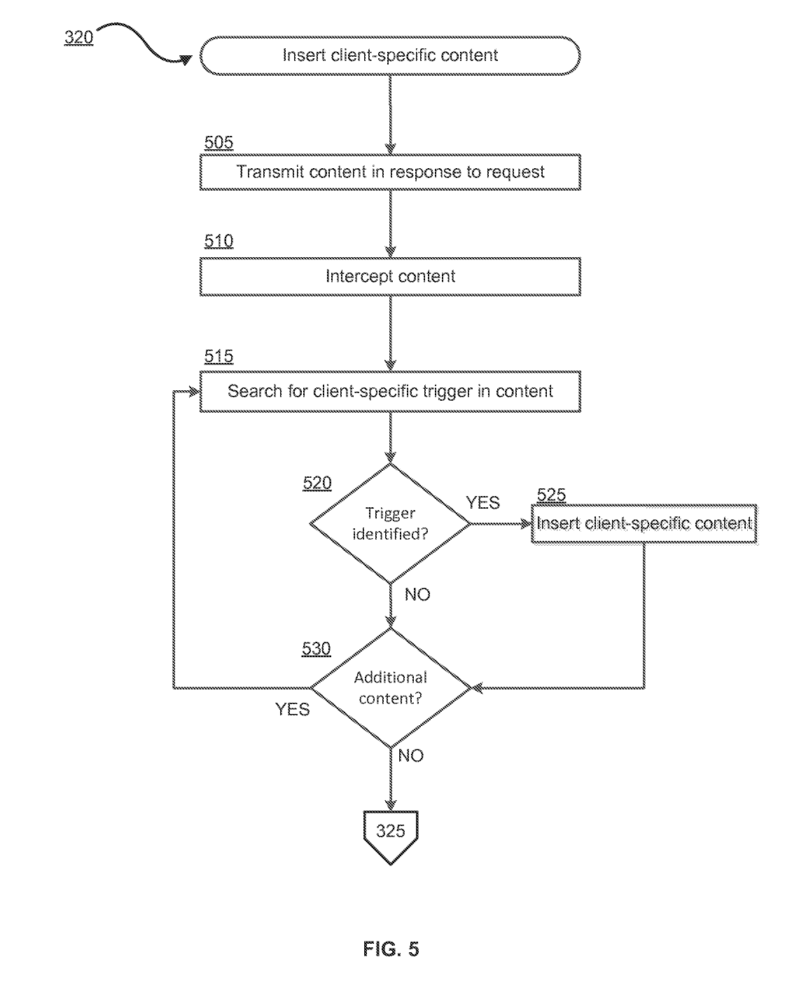

In step 310, it is determined whether individualized content will be delivered by intercepting the response from the server 201 and inserting client-specific (or individualized) content into the response before transmitting the content to a client 205. If the conclusion in step 310 is NO, then the method proceeds to step 315, wherein client-specific content will be obtained by requesting it from a server 201 configured to deliver client-specific content. If, on the other hand, the conclusion in step 310 is YES, the method proceeds to step 320, wherein client-specific content will be inserted after the server 201 has responded to the request. Steps 315 and 320 will be described in greater detail below with respect to FIGS. 5 and 6.

After completing either step 315 or 320, the method proceeds to step 325, wherein the individualized content is transmitted to the client 205 that requested it. The method then ends.

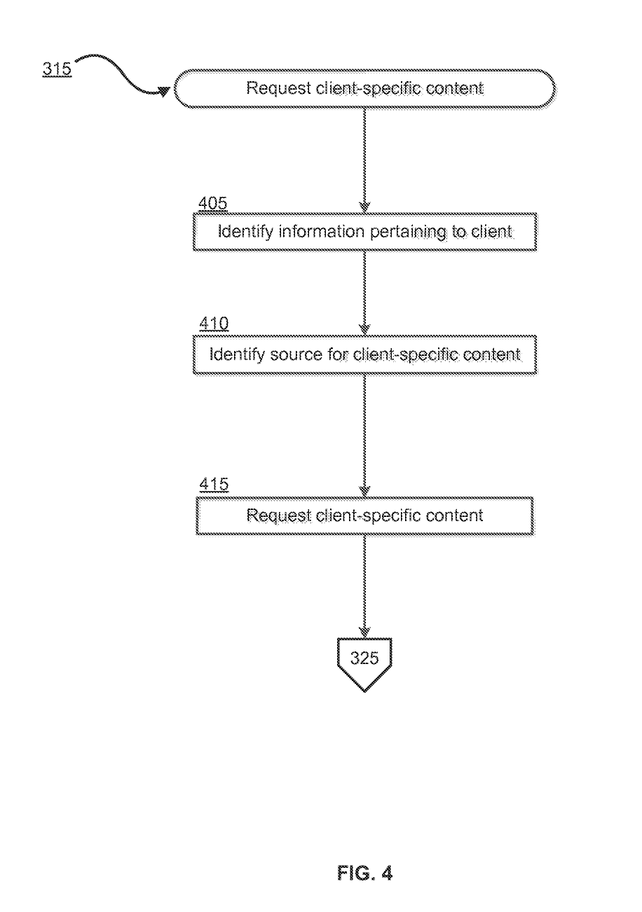

Turning now to FIG. 4, the method 315 for requesting client-specific content is disclosed in greater detail. FIG. 4 will be discussed with respect to FIGS. 1, 2, and 3. Beginning with step 405, the load balancer 203 identifies information pertaining to the client 205 or request in accordance with the exemplary embodiment described above. Based on that information, in step 410 the load balancer 203 identifies the source for the client-specific content by determining the particular server 201, group of servers 201, or location on a particular server 201, to which the request should be directed.

In step 415, the load balancer 203 transmits the request for content to the server 201 identified in step 410. The method then returns to step 325, and the server 201 transmits the individualized content to the client 205.

Turning now to FIG. 5, a method 320 is for inserting client-specific content into a response is disclosed in greater detail. FIG. 5 will be discussed with respect to FIGS. 1, 2, and 3. Beginning with step 505, the load balancer 203 transmits the request for content to the server 201, which then transmits the response back to the load balancer 203 en route to the client 205 that requested the content. In step 510, the load balancer 203 intercepts the content and in step 515 searches for client-specific triggers in the content. Client-specific triggers are described in greater detail above with respect to FIG. 2.

In decision step 520, it is determined if a trigger is identified. If the determination in step 520 is NO, the method proceeds to step 530, wherein it is determined whether additional content is available for analyzing. If, on the other hand, the determination in step 520 is YES, the method proceeds to step 525, wherein client-specific content is inserted at the trigger. Alternatively, the client-specific content can replace the trigger. The method then proceeds to step 530.

In decision step 530, it is determined if additional content remains to be searched for client-specific triggers. If the determination in decision step 530 is YES, the method returns to step 515, wherein the search for client-specific triggers continues. If, on the other hand, the determination in step 530 is NO, the method returns to step 325 of FIG. 3, wherein the individualized content is transmitted to the client 205.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for delivering content, comprising:
receiving a request for content from a requestor;
receiving a response to the request;
searching for a trigger in the response; and
in response to identifying a trigger in the response, inserting content individualized for the requestor into the response.

2. The method of claim 1, wherein the response comprises markup language.

3. The method of claim 1, wherein the trigger comprises a variable in the markup language.

4. The method of claim 2, wherein the content individualized for the requestor comprises markup language.

5. The method of claim 1, wherein the step of searching for a trigger in the response comprises:
intercepting the response after the response has been sent by a server; and
scanning the response for the trigger prior to transmitting the response to the requestor.

6. The method of claim 1, wherein inserting the content individualized for the requestor into the response comprises replacing the trigger with said content.

7. The method of claim 1, wherein the content individualized for the requestor comprises the number of items the requestor has placed in a shopping cart.

8. A method for delivering content, comprising:
receiving a request for content from a requestor;
identifying information pertaining to the request;
identifying a source for content to be delivered to the requestor based on the information;
requesting content from the source; and
delivering content from the source to the requestor.

9. The method of claim 8, wherein the information comprises at least one of a browser type, a browser version, an operating system, a media player type, a location, an IP address, an internet provider, a time of day, a system load, a random number, and a visit frequency.

10. The method of claim 8, wherein the source of the content to be delivered comprises a server.

11. The method of claim 8, further comprising the steps of:
providing a plurality of sources of content;
associating each of said plurality of sources with said information; and
directing the request for content to the source associated with the information pertaining to the request.

12. The method of claim 11, wherein a first source is configured to deliver a first version of a website in response to the request, and wherein a second source is configured to deliver a second version of the website in response to the request.

13. The method of claim 8, wherein the step of identifying information pertaining to the request is performed by a load balancer.

14. A system for delivering content, comprising:
a plurality of servers, each of which is configured to deliver different content; and
a load balancer comprising an association between information pertaining to a request and each of the plurality of servers,
wherein the load balancer, in response to receiving a request, identifies the information pertaining to the request, and directs the request to the server associated with the information pertaining to the request.

15. The system of claim 14, wherein the information pertaining to the request comprises at least one of: a browser type, a browser version, an operating system, a media player type, a location, an IP address, an internet provider, a time of day, a system load, a random number, and a visit frequency.

16. The system of claim 14, wherein the server is a web server.

17. The system of claim 14, wherein the content is a markup language.

18. The system of claim 14, wherein the server is configured to respond to the request, and wherein the load balancer is configured to intercept the response, scan the response for a trigger prior to sending the response to the requestor, and insert content individualized for the requestor into the response prior to transmitting the response to the requestor.

19. The system of claim 18, wherein inserting the content individualized for the requestor comprises replacing the trigger with said content.

20. The system of claim 19, wherein the content individualized for the requestor comprises the number of items a requestor has placed in a shopping cart.
